(19) United States
(12) Patent Application Publication
(10) Pub. No.: US 2013/0261250 A1
(43) Pub. Date: Oct. 3, 2013

(54) ARBORESCENT POLYMERS HAVING A CORE WITH A HIGH GLASS TRANSITION TEMPERATURE AND PROCESS FOR MAKING SAME

(71) Applicants: Goran Stojcevic, Antwerpen (BE); Steven Teertstra, London (CA); Lorenzo Ferrari, Bright's Grove (CA); Kevin Kulbaba, London (CA); Greg Davidson, London (CA)

(72) Inventors: Goran Stojcevic, Antwerpen (BE); Steven Teertstra, London (CA); Lorenzo Ferrari, Bright's Grove (CA); Kevin Kulbaba, London (CA); Greg Davidson, London (CA)

(73) Assignee: LANXESS INC., Sarnia, ON (CA)

(21) Appl. No.: 13/640,541

(22) PCT Filed: Apr. 8, 2011
(86) PCT No.: PCT/CA2011/000379

§ 371 Date: May 31, 2013

Related U.S. Application Data
(60) Provisional application No. 61/324,923, filed on Apr. 16, 2010.

(51) Int. Cl. C08F 212/08; C08F 236/10

(52) U.S. Cl. CPC C08F 212/08; C08F 236/10
USPC 524/548; 525/319; 525/313; 524/578; 525/299; 525/286

(57) ABSTRACT

The present invention relates to arborescent polymers comprising isoolefins and styrenic monomers, as well as processes for making same. In particular, the invention relates to highly branched block copolymers comprising an arborescent core with a high glass-transition temperature (Tg) and branches attached to the core terminated in polymer endblock segments with a low Tg. The copolymers of the invention desirably exhibit thermoplastic elastomeric properties and, in one embodiment, are desirably suited to biomedical applications.

### FIELD OF THE INVENTION

The present invention relates to arborescent polymers and to a process for making same. In particular, the invention relates to highly branched block copolymers comprising an arborescent core with a high glass-transition temperature (Tg) and branches attached to the core terminated in polymer endblock segments with a low Tg. The copolymers of the invention desirably exhibit thermoplastic elastomeric properties. The invention also relates to halogenated arborescent copolymers, cured arborescent copolymer, filled articles comprising the copolymers, and processes for the production of the copolymers.

### BACKGROUND OF THE INVENTION

Arborescent, or highly branched, block copolymers comprising a low Tg inner core with branches terminated in high Tg endblocks are known in the literature. See, for example, U.S. Pat. No. 6,747,098, granted to Puskas et al. These block copolymers are known to exhibit thermoplastic elastomeric properties. Due to the chemical bonds between the high Tg and low Tg segments, these block copolymers also desirably exhibit a lower tendency towards phase separation than is seen with blends of high Tg and low Tg polymers. However, the high Tg branches of these polymers typically are terminated in styrene groups, which contain a benzene ring. In biomedical applications, such as in stents, these benzene containing groups can lead to increased rates of rejection by the body and inflammation at the site of implantation. Potential leaching of residual monomers left over from the polymerization process may also be responsible for a number of adverse effects in vivo, necessitating extensive purification of the final product. It would therefore be desirable to reduce or eliminate styrenic groups from the exterior (branched portion) of the copolymer.

The prior art arborescent block copolymers described above contain a major part of their mass in the branched core and a minor part in the endblock segments. It is currently believed that this arrangement is necessary to achieve the desired thermoplastic elastomeric properties.

Styrenic groups are saturated and retain no double bonds that can be reacted to perform further functional chemistry. In certain applications, it would be desirable to functionalize the endblocks of the copolymer to achieve a desired balance of properties.

There remains a need in the art for improved arborescent block copolymers.

### SUMMARY OF THE INVENTION

The present invention relates to arborescent block copolymers and to processes for making same. The block copolymers comprise a highly branched core of a high Tg material and branches terminated with low Tg endblocks. Surprisingly, these copolymers exhibit thermoplastic elastomeric properties, despite having a majority of their mass in the endblocks and/or having relatively large molecular weight endblocks.

By keeping the high Tg monomers within the interior of the copolymer, inflammation and/or rejection effects may be reduced in vivo. Since the high Tg monomers are allowed to polymerize essentially to completion prior to introduction of the low Tg monomers, and since the high Tg monomers are located within the interior core of the copolymer, there is very little of the high Tg monomer able to leach out into the body. The high Tg core configuration therefore reduces potential toxicity of the materials in vivo and reduces the amount of washing of the final material required to remove the high Tg monomers.

Providing the high Tg monomers within the interior core also has the advantage of increasing adhesion of the copolymers to substrates, particularly cellular substrates. This can be useful in the formation of coatings for a variety of articles, for example stents for use in medical procedures.

Providing the low Tg monomers on the endblocks of the copolymer provides the opportunity for both monoisoolefin and diolefin monomers to be located on the exterior of the copolymer. The diolefin monomers are particularly interesting in that they permit additional chemistry to be performed on the exterior of the copolymer, for example functionalization, such as with maleic anhydride, halogenation, or curing using a variety of curing systems. It is therefore possible to have a cured exterior and a non-cured inner core. This can be advantageous in a number of applications and can permit the copolymers of the invention to be blended with other rubbers, such as butyl rubbers, and optionally co-cured therewith to form new compounds with useful properties.

According to an aspect of the invention, there is provided a highly branched arborescent block copolymer, comprising: an arborescent polymer core having more than one branching point, the arborescent polymer core having a high glass-transition temperature (Tg) of greater than 40° C.; and, branches attached to the arborescent polymer core terminated in polymer endblock segments having a low Tg of less than 40° C.

According to another aspect of the invention, there is provided an end-functionalized arborescent polymer comprising the reaction product of at least one inimer and at least one para-methylstyrene monomer, wherein the end-functionalized arborescent polymer has been end-functionalized with greater than about 65 weight percent end blocks derived from a homopolymer or copolymer having a low glass transition temperature (T_{g}) of less than 40° C.

According to yet another aspect of the invention, there is provided a process for producing a highly branched arborescent copolymer comprising: copolymerizing a reaction mixture comprising at least one inimer and at least one para-methylstyrene monomer in an inert polar solvent in the presence of a Lewis acid halide co-initiator at a temperature of from about −20° C. to about −100° C. to form a highly branched core; monitoring the reaction mixture for a temperature decrease, indicating substantial consumption of the para-methylstyrene monomer; adding an isoolefin monomer to the reaction mixture to form endblocks on the highly branched core, thereby producing the arborescent copolymer; and, separating the arborescent copolymer from the polar solvent.

### BRIEF DESCRIPTION OF THE DRAWINGS

Having summarized the invention, preferred embodiments thereof will now be described with reference to the accompanying figures, in which:

FIG. 1 is a graph depicting the SEC trace for selected polymers according to the present invention;

FIG. 2 is a graph showing thermoplastic properties of Peak Stress versus Peak Elongation for selected polymers according to the present invention;

FIG. 3 is a graph depicting cell viability as a function of rubber leachant concentration in cell growth media; and,

FIG. 4 is a graph depicting cell growth on the material surface as compared to a glass microscope slide as control.

### DETAILED DESCRIPTION OF THE INVENTION

In the specification and claims the word polymer is used generically and encompasses regular polymers (i.e., homopolymers) as well as copolymers, block copolymers, random block copolymers and terpolymers.

The present invention relates to arborescent polymers that have been end-functionalized, where such polymers have been formed from at least one inimer and at least one high Tg monomer, preferably a styrenic monomer, more preferably para-methylstyrene. An exemplary reaction scheme for producing polymers according to this embodiment is shown below as Scheme 1, where each F represents one or more functional end blocks according to the present invention.

In one embodiment, the endblocks F comprise a homopolymer formed from a low Tg monomer, preferably an isoolefin monomer, more preferably isobutene. In another embodiment, the endblocks F comprise a copolymer formed from an isoolefin monomer and a diene monomer, preferably a conjugated diene monomer, such as isoprene.

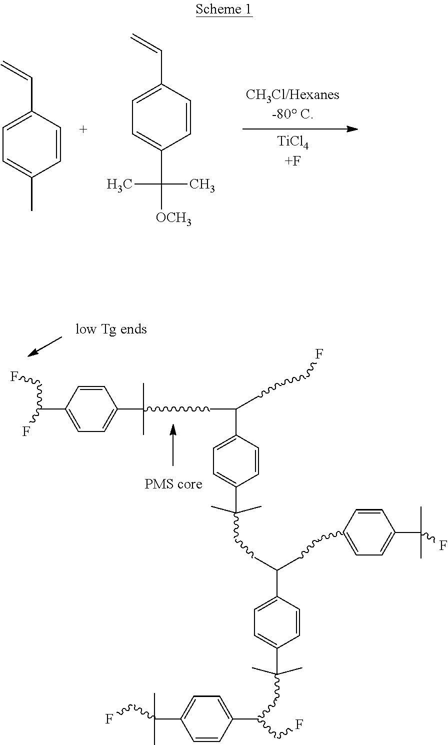

When the endblocks F comprise a copolymer formed from an isoolefin monomer and a diene monomer, it is possible to halogenate the endblocks to form a halogenated arborescent copolymer, which can optionally be cured or used as the basis of further functional chemistry. When a styrenic monomer is used to form the high Tg core, a halogenated polymer can also be formed by bromination of the methyl group attached to the styrenic ring, for example using liquid bromine (Br₂) with a free radical initiator. Halogenated polymers are particularly well suited to non-biomedical applications.

In the present invention, a polymer or copolymer having a low glass transition temperature (Tg) is defined to be a polymer or copolymer having a glass transition temperature of less than about 40° C., or less than about 35° C., or less than about 30° C., or even less than about 25° C. In another embodiment, a polymer or copolymer having a low glass transition temperature is defined to be a polymer or copolymer having a glass transition temperature less than about room temperature (i.e., about 25° C.). It should be noted that the previously stated ranges are intended to encompass any polymers and/or copolymers that have a glass transition temperature that falls below one of the previously stated thresholds. A low Tg monomer is any monomer that can homopolymerize or copolymerize to form a low Tg homopolymer or copolymer. Suitable low Tg monomers include isoolefins within the range of from 4 to 16 carbon atoms, in particular isomonoolefins having 4-7 carbon atoms, such as isobutene, 2-methyl-1-butene, 3-methyl-1-butene, 2-methyl-2-butene, 4-methyl-1-pentene and mixtures thereof. A preferred low Tg isoolefin monomer comprises isobutene.

Conversely, a polymer or copolymer having a high glass transition temperature is defined to be a polymer or copolymer having a glass transition temperature of more than about 40° C., or more than about 45° C., or more than about 50° C., or more even more than about 100° C. It should be noted that the previously stated ranges are intended to encompass any polymers and/or copolymers that have a glass transition temperature that falls above one of the previously stated thresholds. A high Tg monomer is any monomer that can homopolymerize or copolymerize to form a high Tg homopolymer or copolymer. Suitable high Tg monomers according to the present invention include styrenic monomers, particularly those with a reactivity ratio close to that of isobutene, for example those that have an alkyl group in the para position, such as, para-alkylstyrenes. A preferred high Tg styrenic monomer comprises para-methylstyrene.

Polymers according to the present invention comprise a majority of their molecular weight as low Tg endblocks. For example, polymers according to the invention may preferably have at least 65 wt % of low Tg endblocks, more preferably at least 75 wt % of low Tg endblocks, even more preferably at least 80 wt % of low Tg endblocks, yet more preferably at least 85 wt % of low Tg endblocks, still more preferably at least 90 wt % of low Tg endblocks. In another embodiment, polymers according to the invention may comprise from 65 to 95 wt % of low Tg endblocks, from 65 to 90 wt % of low Tg endblocks, or from 75 to 80 wt % of low Tg endblocks.

In another embodiment, the present invention relates to end-functionalized thermoplastic elastomeric arborescent polymers formed from at least one inimer and at least one high Tg monomer (for example a styrenic monomer, such as para-methylstyrene), wherein the end-functionalized portions of such polymers are made from a low Tg monomer (for example, an isoolefin monomer, such as isobutene). Preferably, the end-functionalized portions form homopolymers or copolymers having in aggregate a number average molecular weight of greater than about 50,000 g/mol, greater than about 75,000 g/mol, greater than about 100,000 g/mol, greater than about 150,000 g/mol, greater than about 200,000 g/mol, greater than about 250,000 g/mol, or greater than about 300,000 g/mol. It is surprising that these arborescent copolymers exhibit thermoplastic properties, given the relatively high molecular weight of the low Tg endblocks.

### Inimers:

Initially, self-condensing monomers combine features of a monomer and an initiator and the term “inimer” (IM) is used describe such compounds. If a small amount of a suitable inimer is copolymerized with, for example, isobutylene, arborescent polyisobutylenes can be synthesized. Formula (I) below details the nature of the inimer compounds that can be used in conjunction with the present invention. In Formula (I) A represents the polymerizable portion of the inimer compound, while B represents the initiator portion of the inimer compound.

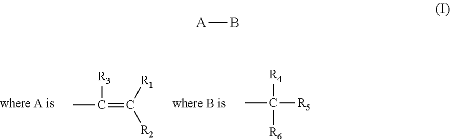

In Formula (I), R₁, R₂, R₃, R₄, R₅ and R₆ are each, in one embodiment, independently selected from hydrogen, linear or branched C₁ to C₁₀ alkyl, or C₅ to C₈ aryl. In another embodiment, R₁, R₂, and R₃ are all hydrogen. In another embodiment, R₄, R₅ and R₆ are each independently selected from hydrogen, hydroxyl, bromine, chlorine, fluorine, iodine, ester (—O—C(O)—R₇), peroxide (—OOR₇), and —O—R₇ (e.g., —OCH₃ or —OCH₂═CH₃). With regard to R₇, R₇ is an unsubstituted linear or branched C₁ to C₂₀ alkyl, an unsubstituted linear or branched C₁ to C₁₀ alkyl, a substituted linear or branched C₁ to C₂₀ alkyl, a substituted linear or branched C₁ to C₁₀ alkyl, an aryl group having from 2 to about 20 carbon atoms, an aryl group having from 9 to 15 carbon atoms, a substituted aryl group having from 2 to about 20 carbon atoms, a substituted aryl group having from 9 to 15 carbon atoms. In one embodiment, where one of R₄, R₅ and R₆ either a chlorine or fluorine, the remaining two of R₄, R₅ and R₆ are independently selected from an unsubstituted linear or branched C₁ to C₂₀ alkyl, an unsubstituted linear or branched C₁ to C₁₀ alkyl, a substituted linear or branched C₁ to C₂₀ alkyl, a substituted linear or branched C₁ to C₁₀ alkyl. In still another embodiment, any two of R₄, R₅ and R₆ can together form an epoxide.

In one embodiment, portions A and B of inimer compound (I) are joined to one another via a benzene ring. In one instance, portion A of inimer compound (I) is located at the 1 position of the benzene ring while portion B is located at either the 3 or 4 position of the benzene ring. In another embodiment, portions A and B of inimer compound (I) are joined to one another via the linkage shown below in Formula (II):

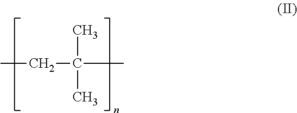

where n is an integer in the range of 1 to about 12, or from 1 to about 6, or even from 1 to about 3. In another embodiment, n is equal to 1 or 2.

In another embodiment, for isobutylene polymerization B can be a tertiary ether, tertiary chloride, tertiary methoxy group or tertiary ester. Very high molecular weight arborescent PIBs can be synthesized using the process of the present invention with inimers such as 4-(2-hydroxy-isopropyl)styrene and 4-(2-methoxy-isopropyl)styrene.

Exemplary inimers for use in conjunction with the present invention include, but are not limited to, 4-(2-hydroxyisopropyl)styrene, 4-(2-methoxyisopropyl)styrene, 4-(1-methoxyisopropyl)styrene, 4-(2-chloroisopropyl)styrene, 4-(2-acetoxyisopropyl)styrene, 2,3,5,6-tertamethyl-4-(2-hydroxy isopropyl)styrene, 3-(2-methoxyisopropyl)styrene, 4-(epoxyisopropyl)styrene, 4,4,6-trimethyl-6-hydroxyl-1-heptene, 4,4,6-trimethyl-6-chloro-1-heptene, 4,4,6-trimethyl-6,7-epoxy-1-heptene, 4,4,6,6,8-pentamethyl-8-hydroxyl-1-nonene, 4,4,6,6,8-pentamethyl-8-chloro-1-nonene, 4,4,6,6,8-pentamethyl-8,9-epoxy-1-nonene, 3,3,5-trimethyl-5-hydroxyl-1-hexene, 3,3,5-trimethyl-5-chloro-1-hexene, 3,3,5-trimethyl-5-6-epoxy-1-hexene, 3,3,5,5,7-pentamethyl-7-hydroxyl-1-octene, 3,3,5,5,7-pentamethyl-7-chloro-1-octene, or 3,3,5,5,7-pentamethyl-7,8-epoxy-1-octene. In one embodiment, the inimer of the present invention is selected from 4-(2-methoxyisopropyl)styrene or 4-(epoxyisopropyl)styrene.

In still another embodiment, the inimer utilized in conjunction with the present invention has a formula according to one of those shown below:

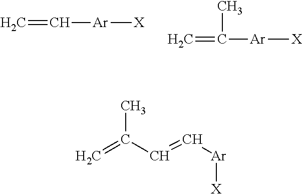

wherein X corresponds to a functional organic group from the series —CR¹₂Y, where Y represents OR, Cl, Br, I, CN, N₃ or SCN and R¹ represents H and/or a C₁ to C₂₀ alkyl, and Ar represents C₆H₄ or C₁₀H₈.

It is desirable that the inimer is substantially pure in order to avoid potentially poisoning the reaction process. The inimer is preferably at least 90% pure. For the production of arborescent polymers according to the invention intended for biomedical applications, a higher level of purity may be preferred, for example 95% or even 99%.

In one embodiment, 4-(2-methoxyisopropyl)styrene or 4-(epoxyisopropyl)styrene is used as the inimer and a styrenic monomer comprising para-methylstyrene is used as the high Tg monomer, as will be described in detail below, to yield the core of an arborescent polymer as shown in step A of Scheme 2.

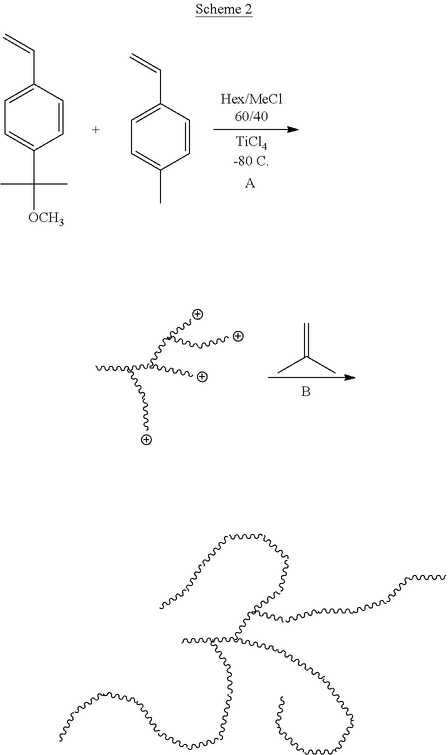

After the reaction temperature decreases, indicating that substantially all of the para-methylstyrene is consumed in formation of the high Tg core, isobutene is added to the system as the low Tg isoolefin monomer and polymerized at the branching points of the inimer to yield an arborescent copolymer having low Tg endblocks, as shown in step B of Scheme 2.

Using the process of the present invention, the structure of arborescent polymers can be varied within a wide range. This structural variation is illustrated by the branching index. For example, the branching index, molecular weight and physical properties of arborescent polymers according to the present invention can be controlled via the molar ratios of inimer and monomer added to the polymerization charge. For example, decreasing the concentration of inimer relative to the concentration of high Tg monomer in the feed will result in longer chains with reduced degrees of branching and a lower branching index. Conversely, increasing the concentration of inimer relative to the amount of high Tg leads to the formation of a polymer with a highly branched structure having shorter arm lengths with a higher branching index. Further alteration of the arborescent core can be achieved by the sequential addition of inimer and/or monomer throughout the polymerization process.

Polymers according to the present invention preferably have a molecular weight (Mw) in the range of from about 100,000 to about 700,000, more preferably from about 200,000 to about 500,000, yet more preferably from about 300,000 to about 450,000. The polymers preferably have a branching index (BR) of from 0.5 to 20, more preferably 0.9 to 10. The polymers preferably have a narrow molecular weight distribution characterized by a polydispersity index (M_{w}/Mₙ, or PDI) of from 1 to 4.5, more preferably from 1.2 to 3.5, or from about 1.9 to about 3.2. The above properties may be present individually or in any combination with one another.

Distinct changes in the rheological properties of a polymer formed in accordance with the present invention are made possible by changes in the chain architecture. Arborescent polymers formed in accordance with the present invention may have reduced shear sensitivity due to the branched structure, and reduced viscosity compared to linear polymers of equivalent chain length. They are preferably bi-phasic, having a blocky structure, as indicated by the presence of two distinct glass transition temperatures (Tg's). They preferably exhibit thermoplastic properties, expressed in terms of enhanced re-inforcement as compared with conventional butyl rubber controls. Unfilled and uncured polymer according to the present invention preferably have a peak elongation in the range of from 5 to 400%, more preferably 9 to 375%, even more preferably 250 to 375%. Unfilled and uncured polymers according to the present invention preferably have a peak stress of from 0.25 to 2.5 MPa, more preferably from 0.5 to 2.0 MPa, even more preferably from 0.59 to 1.66 MPa. Any combination of the foregoing physical properties may also be provided.

The above embodiments of polymers according to the present invention are particularly useful in biomedical applications. 250 mg samples of the polymers according to the invention preferably produce less than 100 ppm of any single leachable compound when analyzed by GC-MS after 300 hours of extraction in 5 mL of de-ionized water at 40° C., more preferably less than 10 ppm, even more preferably less than 1 ppm. Cells, particularly mouse myoblast cells, incubated in the leachate solutions preferably exhibit at least 80% cell viability when cultured for 48 hours at a temperature of at least 37° C., more preferably 40° C. Surfaces of the polymers according to the invention preferably support cell growth, particularly the growth of mammalian cells, for example mouse myoblast cells. The surfaces preferably support an increase in the number of cells of at least 50% when growth media solutions are incubated with the polymers for at least 24 hours at body temperature conditions of at least 37° C., preferably 40° C. The cells preferably adhere to the polymer surface. The above polymers according to the invention are therefore preferably bio-compatible and non-toxic to cell growth.

In one embodiment, the process according to the present invention is carried out in an inert organic solvent or solvent mixture in order that the high Tg core copolymer and the final arborescent copolymer product remain in solution. At the same time, the solvent also provides a degree of polarity so that the polymerization process can proceed at a reasonable rate. Suitable solvents include single solvents such as n-butyl chloride. In another embodiment, a mixture of a non-polar solvent and a polar solvent can be used. Suitable non-polar solvents include, but are not limited to, hexane, methylcyclohexane and cyclohexene. Suitable polar solvents include, but are not limited to, ethyl chloride, methyl chloride and methylene chloride. In one embodiment, the solvent mixture is a combination of methylcyclohexane and methyl chloride, or even hexane and methyl chloride. To achieve suitable solubility and polarity it has been found that the ratio of the non-polar solvent to the polar solvent on a weight basis should be from about 80:20 to about 40:60, from about 75:25 to about 45:55, from about 70:30 to about 50:50, or even about 60:40. Again, here, as well as elsewhere in the specification and claims, individual range limits may be combined.

The temperature range within which the process is carried out is from about −20° C. to about −100° C., or from about −30° C. to about −90° C., or from about −40° C. to about −85° C., or even from about −50° C. to about −80° C. The process of the present invention is, in one embodiment, carried out using an about 1 to about 30 percent para-methylstyrene solution (weight/weight basis), or even from about 5 to about 10 weight percent paramethylstyrene solution.

In order to produce the arborescent polymers of the present invention a co-initiator (e.g., a Lewis acid halide) is used. Suitable Lewis acid halide co-initiators include, but are not limited to, BCl₃, BF₃, AlCl₃, SnCl₄, TiCl₄, SbF₅, SeCl₃, ZnCl₂, FeCl₃, VCl₄, AlRₙCl₃₋ₙ, wherein R is an alkyl group and n is less than 3, such as diethyl aluminum chloride and ethyl aluminum dichloride, and mixtures thereof. In one embodiment, titanium tetrachloride (TiCl₄) is used as the co-initiator.

The branched block copolymers of the present invention can also be produced in a one-step process wherein the high Tg monomer is co-polymerized with the initiator monomer in conjunction with the co-initiator in a solution at a temperature of from about −20° C. to about −100° C., or from about −30° C. to about −90° C., or from about −40° C. to about −85° C., or even from about −50° C. to about −80° C. An electron donor and a proton trap are introduced, followed by the addition of a pre-chilled solution of the co-initiator in a non-polar solvent (e.g., hexane). The polymerization is allowed to continue until it is terminated by the addition of a nucleophile such as methanol.

In some embodiments, production of arborescent polymers in accordance with the present invention necessitates the use of additives such as electron pair donors to improve blocking efficiency and proton traps to minimize homopolymerization. Examples of suitable electron pair donors are those nucleophiles that have an electron donor number of at least 15 and no more than 50 as tabulated by Viktor Gutmann in The Donor Acceptor Approach to Molecular Interactions, Plenum Press (1978) and include, but are not limited to, ethyl acetate, dimethylacetamide, dimethylformamide and dimethyl sulphoxide. Suitable proton traps include, but are not limited to, 2,6-ditertiarybutylpyridine, 4-methyl-2,6-ditertiarybutylpyridine and diisopropylethylamine.

In yet another embodiment, suitable for non-biomedical applications, the present invention relates to end-functionalized thermoplastic elastomeric arborescent polymers that are reinforced with one or more fillers, where the one or more fillers preferentially interact with the end-functionalized portions of such arborescent polymers. Fillers may include mineral or non-mineral fillers.

Exemplary mineral fillers include silica silica, silicates, clay (such as bentonite), gypsum, alumina, titanium dioxide, talc and the like, as well as mixtures thereof. More specific examples include: highly dispersable silicas, prepared e.g. by the precipitation of silicate solutions or the flame hydrolysis of silicon halides, with specific surface areas of 5 to 1000, preferably 20 to 400 m²/g (BET specific surface area), and with primary particle sizes of 10 to 400 nm; the silicas can optionally also be present as mixed oxides with other metal oxides such as those of Al, Mg, Ca, Ba, Zn, Zr and Ti; synthetic silicates, such as aluminum silicate and alkaline earth metal silicates; magnesium silicate or calcium silicate, with BET specific surface areas of 20 to 400 m²/g and primary particle diameters of 10 to 400 nm; natural silicates, such as kaolin and other naturally occurring silica; glass fibres and glass fibre products (matting, extrudates) or glass microspheres; metal oxides, such as zinc oxide, calcium oxide, magnesium oxide and aluminium oxide; metal carbonates, such as magnesium carbonate, calcium carbonate and zinc carbonate; metal hydroxides, e.g. aluminium hydroxide and magnesium hydroxide; or, combinations thereof.

Exemplary non-mineral fillers include carbon black, for example carbon prepared by the lamp black, furnace black or gas black process, preferably having a BET specific surface area of 20 to 200 m²/g, such as SAF, ISAF, HAF, FEF or GPF carbon black. Other non-mineral fillers include rubber gels, especially those based on polybutadiene, butadiene/styrene copolymers, butadiene/acrylonitrile copolymers or polychloroprene rubbers.

In the case where one or more fillers are utilized in conjunction with the present invention, the filler can be bound, attached, captured and/or entrained by the end-functionalized portion of the arborescent polymers of the present invention rather than by the core portion thereof.

In yet another embodiment, again suitable for non-biomedical applications, the present invention provides a rubber composition comprising at least one, optionally halogenated, arborescent polymer, at least one filler and at least one vulcanizing agent. In order to provide a vulcanizable rubber compound, at least one vulcanizing agent or curing system has to be added. The present invention is not limited to any one type of curing system. An exemplary curing system is a sulfur curing system, although a peroxide based curing system may also be used. For sulfur based curing systems, the amount of sulfur utilized in the curing process can be in the range of from about 0.3 to about 2.0 phr (parts by weight per hundred parts of rubber). An activator, for example zinc oxide, can also be used. If present, the amount of activator ranges from about 0.5 parts to about 5 parts by weight.

Other ingredients, for instance stearic acid, oils (e.g., Sunpar® of Sunoco), antioxidants, or accelerators (e.g., a sulfur compound such as dibenzothiazyldisulfide (e.g., Vulkacit® DM/C of Bayer AG) can also be added to the compound prior to curing. Curing (e.g., sulfur-based cure) is then effected in a known manner. See, for instance, Chapter 2, The Compounding and Vulcanization of Rubber, in Rubber Technology, Third Edition, Chapman & Hall, 1995. This publication is hereby incorporated by reference for its teachings relating to cure systems.

The vulcanizable rubber compound according to the present invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc. Such compounds, additives, and/or products are known in/to the rubber industry. The rubber aids are used in conventional amounts, which depend on the intended use. Conventional amounts are, for example, from about 0.1 to about 50 phr. In one embodiment, the vulcanizable compound comprising a solution blend further comprises in the range of about 0.1 to about 20 phr of one or more organic fatty acids as an auxiliary product. In one embodiment, the unsaturated fatty acid has one, two or more carbon double bonds in the molecule which can include about 10% by weight or more of a conjugated diene acid having at least one conjugated carbon-carbon double bond in its molecule. In another embodiment, the fatty acids used in conjunction with the present invention have from about 8 to about 22 carbon atoms, or even from about 12 to about 18 carbon atoms. Suitable examples include, but are not limited to, stearic acid, palmitic acid and oleic acid and their calcium-, zinc-, potassium-, magnesium- and ammonium salts. Furthermore up to about 40 parts of processing oil, or even from about 5 to about 20 parts of processing oil, per hundred parts of elastomer, can be present.

It may be advantageous to further add silica modifying silanes, which give enhanced physical properties to silica or silicious filler containing compounds. Compounds of this type possess a reactive silylether functionality (for reaction with the silica surface) and a rubber-specific functional group. Examples of these modifiers include, but are not limited to, bis(triethoxysilylpropyl)tetrasulfane, bis(triethoxy-silylpropyl)disulfane, or thiopropionic acid S-triethoxylsilyl-methyl ester. The amount of silica modifying silane is in the range of from about 0.5 to about 15 parts per hundred parts of elastomer, or from about 1 to about 10, or even from about 2 to about 8 parts per hundred parts of elastomers. The silica modifying silane can be used alone or in conjunction with other substances which serve to modify the silica surface chemistry.

The ingredients of the final vulcanizable rubber compound comprising the rubber compound are often mixed together, suitably at an elevated temperature that can range from about 25° C. to about 200° C. Normally the mixing time does not exceed one hour and a time in the range from about 2 to about 30 minutes is usually adequate. Mixing is suitably carried out in an internal mixer such as a Banbury mixer, or a Haake or Brabender miniature internal mixer. A two roll mill mixer also provides a good dispersion of the additives within the elastomer. An extruder also provides good mixing, and permits shorter mixing times. It is possible to carry out the mixing in two or more stages, and the mixing can be done in different apparatus, for example one stage in an internal mixer and one stage in an extruder. For compounding and vulcanization see also: Encyclopedia of Polymer Science and Engineering, Volume 4, p. 66 et seq. (Compounding) and Volume 17, p. 666 et seq. (Vulcanization). This publication is hereby incorporated by reference for its teachings relating to compounding and vulcanization.

In still another embodiment, in the case where the arborescent polymers of the present invention are end-functionalized, the core portion (e.g., the styrenic portion) is not cured, whereas the end-functionalized portion is cured. This permits, among other things, for such arborescent polymers to undergo peroxide cure without causing damage to the overall arborescent polymer structure.

### EXAMPLES

The following examples are descriptions of methods within the scope of the present invention, and use of certain compositions of the present invention as described in detail above. The following examples fall within the scope of, and serve to exemplify, the more generally described compositions, formulations and processes set forth above. As such, the examples are not meant to limit in any way the scope of the present invention.

Polymers according to the invention are prepared as will be discussed in detail below. All polymerizations are carried out in an MBraun MB 15OB-G-1 dry box.

### Chemicals

4-(2-methoxy-isopropyl)styrene (p-methoxycumyl styrene, pMeOCumSt) is synthesized, while isobutylene and methyl chloride are used without further purification from a suitable production unit. Isoprene (IP, 99.9% and available from Aldrich) is passed through a p-tert-butylcatechol inhibitor remover column prior to usage and p-methylstyrene (pMeSt, Aldrich) was distilled under reduced pressure from calcium hydride.

### Test Methods

The molecular weight and molecular weight distributions of the polymers are determined by size exclusion chromatography (SEC). The system consists of a Waters 515 HPLC pump, a Waters 2487 Dual Absorbance Detector, a Wyatt Optilab Dsp Interferometric Refractometer, a Wyatt DAWN EOS multi-angle light scattering detector, a Wyatt Viscostar viscometer, a Wyatt QELS quasi-elastic light scattering instrument, a 717plus autosampler and 6 Styragel® columns (HR½, HR1, HR3, HR4, HR5 and H6). The RI detector and the columns are thermostated at 35° C. and THF freshly distilled from CaH₂ is used as the mobile phase at a flow rate of 1 mL/min. The results are analyzed using ASTRA software (Wyatt Technology). Molecular weight calculation is carried out using 100% mass recovery as well as 0.108 cm³/g do/dc value.

¹H NMR measurements are conducted using a Bruker Avance 500 instrument and deuterated chloroform or THF as the solvent.

Differential Scanning Calorimetry (DSC) analysis was performed using a TA Instruments 2910 differential scanning calorimeter. Samples of 5-15 mg were placed into aluminum sample pans for testing and analyzed for glass transition temperatures (Tg's) under a helium atmosphere between −140° C. and 200° C. with a heating rate of 30° C./min. The reported Tgs were taken as the mean value between the onset and end point temperatures.

Tensiometry measurements were obtained using an Alpha Technologies T2000 tensiometer. Dumbbells with widths of 2.5 mm and 4 mm were diecut from compression molded sheets. Samples were pulled at 100 mm/min to observe the stress-elongation relationship.

### Example 1 (09TS23)

Polymerization was carried out in a 500 cm³ round shape three neck glass reactor. The reactor was equipped with a glass stirrer rod (mounted with a crescent shaped Teflon impeller) and a thermocouple. To the reactor were added 0.105 cm³ of pMeOCumSt, 135 cm³ methylcyclohexane (measured at room temperature), 90 cm³ methyl chloride (measured at −80° C.), 0.3 cm³ di-tert-butylpyridine (measured at room temperature) and 10 cm³ p-methylstyrene (measured at room temperature). Polymerization was started at −80° C. by addition of a pre-chilled mixture of 1.2 cm³ TiCl₄ and 5 cm³ methylcyclohexane (both measured at room temperature). After 20 minutes of polymerization, a temperature decrease was observed and a mixture of 36 cm³ isobutylene (measured at −80° C.), 15 cm³ of methylcyclohexane (measured at room temperature), 10.5 cm³ methyl chloride (measured at −95° C.) and 0.1 cm³ di-tert-butylpyridine (measured at room temperature) was added. Polymerization was terminated at 95 minutes by the addition of 10 cm³ methanol containing 1.65 grams of NaOH. After the evaporation of methyl chloride, methylcyclohexane was added to the polymer solution and the diluted solution was filtered through a medium sintered frit to remove TiO₂, and precipitated directly into acetone. The polymer product was isolated and dried in a vacuum oven for 24 hours at 60° C. The dried weight of the polymer was 17.0 grams. Molecular weight, PDI and branching frequency of the polymer are shown in Table 1. Glass transition temperature is shown in Table 2.

### Example 2 (09TS25)

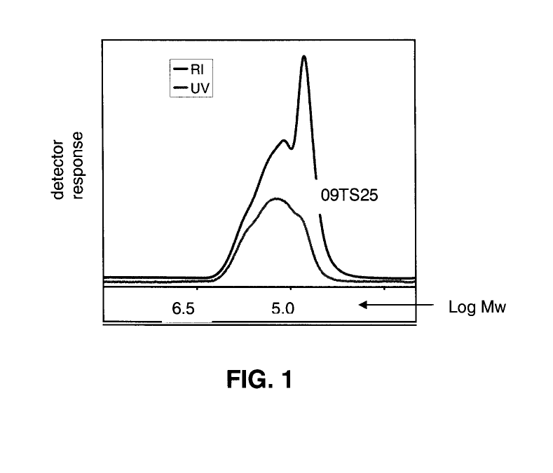

Polymerization was carried out in a 500 cm³ round shape three neck glass reactor. The reactor was equipped with a glass stirrer rod (mounted with a crescent shaped Teflon impeller) and a thermocouple. To the reactor were added a first amount of 0.055 cm³ of pMeOCumSt inimer, 135 cm³ methylcyclohexane (measured at room temperature), 90 cm³ methyl chloride (measured at −80° C.), 0.3 cm³ di-tert-butylpyridine (measured at room temperature) and 10 cm³ p-methylstyrene (measured at room temperature). Polymerization was started at −80° C. by addition of a pre-chilled mixture of 0.6 cm³ TiCl₄ and 2.5 cm³ methylcyclohexane (both measured at room temperature). After 20 minutes of polymerization, a temperature decrease was observed and a mixture of 36 cm³ isobutylene (measured at −80° C.), 15 cm³ of methylcyclohexane (measured at room temperature), 10.5 cm³ methyl chloride (measured at −95° C.) and 0.1 cm³ di-tert-butylpyridine (measured at room temperature) was added. After 30 mins, a second amount of 0.055 cm³ of pMeOCumSt inimer was added, followed by 0.6 cm³ of TiCl₄ and 2.5 cm³ of methylcyclohexane (pre-chilled). Polymerization was terminated at 95 minutes by the addition of 10 cm³ methanol containing 1.65 grams of NaOH. After the evaporation of methyl chloride, methylcyclohexane was added to the polymer solution and the diluted solution was filtered through a medium sintered frit to remove TiO₂, and precipitated directly into acetone. The polymer product was isolated and dried in a vacuum oven for 24 hours at 60° C. The dried weight of the polymer was 16.0 grams. Molecular weight, PDI and branching frequency of the polymer are shown in Table 1. Glass transition temperature is shown in Table 2. A SEC trace for the polymer is shown in FIG. 1.

### Example 3 (09TS27)

Polymerization was carried out in a 500 cm³ round shape three neck glass reactor. The reactor was equipped with a glass stirrer rod (mounted with a crescent shaped Teflon impeller) and a thermocouple. To the reactor were added 0.21 cm³ of pMeOCumSt, 135 cm³ methylcyclohexane (measured at room temperature), 90 cm³ methyl chloride (measured at −80° C.), 0.3 cm³ di-tert-butylpyridine (measured at room temperature) and 10 cm³ p-methylstyrene (measured at room temperature). Polymerization was started at −80° C. by addition of a pre-chilled mixture of 2.4 cm³ TiCl₄ and 7.5 cm³ methylcyclohexane (both measured at room temperature). After 30 minutes of polymerization, a temperature decrease was observed and a mixture of 36 cm³ isobutylene (measured at −80° C.), 15 cm³ of methylcyclohexane (measured at room temperature), 10.5 cm³ methyl chloride (measured at −95° C.) and 0.1 cm³ di-tert-butylpyridine (measured at room temperature) was added. Polymerization was terminated at 95 minutes by the addition of 10 cm³ methanol containing 1.65 grams of NaOH. After the evaporation of methyl chloride, methylcyclohexane was added to the polymer solution and the diluted solution is filtered through a medium sintered frit to remove TiO₂, and precipitated directly into acetone. The polymer product was isolated and dried in a vacuum oven for 24 hours at 60° C. The dried weight of the polymer was 18.0 grams. Molecular weight, PDI and branching frequency of the polymer are shown in Table 1. Glass transition temperature is shown in Table 2.

### Example 4 (L029-2)

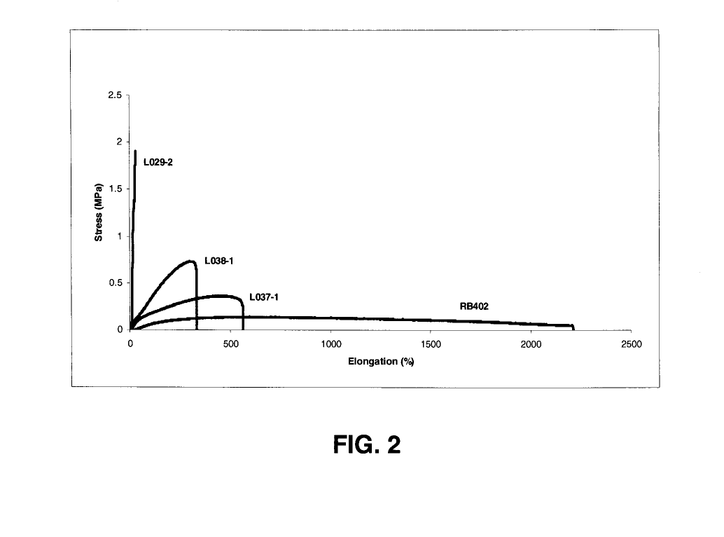

Polymerization was carried out in a 500 cm³ round shape three neck glass reactor. The reactor was equipped with a glass stirrer rod (mounted with a crescent shaped Teflon impeller) and a thermocouple. To the reactor were added 0.100 cm³ of pMeOCumSt, 160 cm³ methylcyclohexane (measured at room temperature), 70 cm³ methyl chloride (measured at −80° C.), 0.3 cm³ di-tert-butylpyridine (measured at room temperature) and 10 cm³ p-methylstyrene (measured at room temperature). Polymerization was started at −80° C. by addition of a pre-chilled mixture of 1.5 cm³ TiCl₄ and 5 cm³ methylcyclohexane (both measured at room temperature). After 20 minutes of polymerization, a temperature decrease was observed and a mixture of 36 cm³ isobutylene (measured at −80° C.), 15 cm³ of methylcyclohexane (measured at room temperature), 10.5 cm³ methyl chloride (measured at −95° C.) and 0.1 cm³ di-tert-butylpyridine (measured at room temperature) was added. Polymerization was terminated at 85 minutes by the addition of 10 cm³ methanol containing 1.65 grams of NaOH. After the evaporation of methyl chloride, methylcyclohexane was added to the polymer solution and the diluted solution was filtered through a medium sintered frit to remove TiO₂, and precipitated directly into acetone. The polymer product was isolated and dried in a vacuum oven for 24 hours at 60° C. Molecular weight, PDI and branching frequency of the polymer are shown in Table 1. Thermoplastic properties of Peak Stress versus Peak Elongation are reported in Table 3 and illustrated in FIG. 2.

### Example 5 (L038-1)

Polymerization was carried out in a 500 cm³ round shape three neck glass reactor. The reactor was equipped with a glass stirrer rod (mounted with a crescent shaped Teflon impeller) and a thermocouple. To the reactor were added 0.100 cm³ of pMeOCumSt, 160 cm³ methylcyclohexane (measured at room temperature), 70 cm³ methyl chloride (measured at −80° C. and 10 cm³ p-methylstyrene (measured at room temperature). Polymerization was started at −80° C. by addition of a pre-chilled mixture of 1.5 cm³ TiCl₄ and 5 cm³ methylcyclohexane (both measured at room temperature). After 20 minutes of polymerization, a temperature decrease was observed and a mixture of 72 cm³ isobutylene (measured at −80° C.) and 90 cm³ methyl chloride (measured at −95° C.) was added. Polymerization was terminated at 85 minutes by the addition of 10 cm³ methanol containing 1.65 grams of NaOH. After the evaporation of methyl chloride, methylcyclohexane was added to the polymer solution and the diluted solution was filtered through a medium sintered frit to remove TiO₂, and precipitated directly into acetone. The polymer product was isolated and dried in a vacuum oven for 24 hours at 60° C. Molecular weight, PDI and branching frequency of the polymer are shown in Table 1. Thermoplastic properties of Peak Stress versus Peak Elongation are reported in Table 3 and illustrated in FIG. 2.

### Example 6 (L037-1)

Polymerization was carried out in a 500 cm³ round shape three neck glass reactor. The reactor was equipped with a glass stirrer rod (mounted with a crescent shaped Teflon impeller) and a thermocouple. To the reactor were added 0.100 cm³ of pMeOCumSt, 160 cm³ methylcyclohexane (measured at room temperature), 70 cm³ methyl chloride (measured at −80° C. and 10 cm³ p-methylstyrene (measured at room temperature). Polymerization was started at −80° C. by addition of a pre-chilled mixture of 1.5 cm³ TiCl₄ and 5 cm³ methylcyclohexane (both measured at room temperature). After 20 minutes of polymerization, a temperature decrease was observed and a mixture of 54 cm³ isobutylene (measured at −80° C.) and 90 cm³ methyl chloride (measured at −95° C.) was added. Polymerization was terminated at 85 minutes by the addition of 10 cm³ methanol containing 1.65 grams of NaOH. After the evaporation of methyl chloride, methylcyclohexane was added to the polymer solution and the diluted solution was filtered through a medium sintered frit to remove TiO₂, and precipitated directly into acetone. The polymer product was isolated and dried in a vacuum oven for 24 hours at 60° C. Molecular weight, PDI and branching frequency of the polymer are shown in Table 1. Thermoplastic properties of Peak Stress versus Peak Elongation are reported in Table 3 and illustrated in FIG. 2.

TABLE 1
Molecular Weight (Mw) and PDI and Branching Frequency
for Polymers of the Invention

| | | | pMeSt | |
|---|---|---|---|---|
| Example | Mw | PDI | (wt %) | BR |
| 1 (09TS23) | 381,000 | 2.97 | 24.4 | 2.2 |
| 2 (09TS25) | 370,000 | 3.18 | 24.5 | 2.0 |
| 3 (09TS27) | 437,000 | 2.09 | 21.2 | 9.4 |
| 4 (L029-2) | 320,000 | 2.60 | 34.5 | 1.9 |
| 5 (L038-1) | 219,000 | 1.99 | 11.8 | 0.9 |
| 6 (L037-1) | 300,000 | 1.95 | 8.7 | 1.1 |

The branching frequency (BR), or degree of branching, is a theoretical calculation using the measured Mn of the polymer and the theoretical Mn of the polymer assuming the inimer species acts only as an initiator and does not participate in branching. For all of the foregoing Examples 1-6, BR=[Mn/Mn(theo)]−1. PDI=Mw/Mn; therefore, to convert from Mw to Mn, divide Mw by PDI.

All of these arborescent polymers have acceptable molecular weight and PDI values within the expected range.

TABLE 2
Glass Transition Temperature for Polymers of the Invention

| Example | T_{g}¹ (° C.) | T_{g}² (° C.) |
|---|---|---|
| 1 (09TS23) | −62.01 | 119.48 |
| 2 (09TS25) | −60.90 | 120.87 |
| 3 (09TS27) | −61.69 | 118.62 |

DSC analysis of Examples 1-3 showed that each material exhibited two distinct glass transition temperatures, which confirms a biphasic composition. The SEC trace of FIG. 1 confirms that the polymer of Example 2 has two distinct peaks, which means that the polymer has a bimodal molecular weight distribution indicative of an arborescent structure. Furthermore, by looking at the relative amount of each peak, it can be seen that the endblocks have a high molecular weight.

TABLE 3
Thermoplastic Properties - Stress vs. Elongation

| | | | Peak Stress |
|---|---|---|---|
| Example | pMeSty (wt %) | Peak Elongation (%) | (MPa) |
| 4 (L029-2) | 34.5 | 9.5 | 1.66 |
| 5 (L038-1) | 11.8 | 375 | 0.99 |
| 6 (L037-1) | 8.7 | 353 | 0.59 |
| Control (RB402 ™) | 0 | 245 | 0.24 |

Thermoplastic elastomer characterization was performed by tensiometry (green strength). Examples 4-6 were compared to commercial grade butyl rubber (RB402™, LANXESS Inc., Canada). Reinforcement of the native films was observed relative to RB402™; the thermoplastic properties of the material are illustrated in FIG. 2. The native uncured materials were tested with no additives or fillers.

### Example 7

### Leaching

Four 250 mg samples of material according to the invention were placed in vials (4 dram), to which 5 mL of deionized water or colorless buffer solutions (pH 5, 7.38, or 9) were added. The vials were placed in a 40° C. incubator oven for approximately 300 hours. The material was removed from the solution and 1 mL of hexane was used to extract material leachants from the aqueous phase. The liquid-liquid extraction using hexane was performed a total of three times on the aqueous phase, following which the hexane was dried using magnesium sulfate. The solution was analyzed by gas chromatography mass spectrometry using a HP 6890 GC system and a HP5973 mass selector device equipped with an Agilent column with DB-624 stationary phase (125-1334, 30 m×0.535 mm×3.00 μm). There was no evidence of any leachant substances, other than those already present in the hexane.

### Example 8

### Cell Toxicity

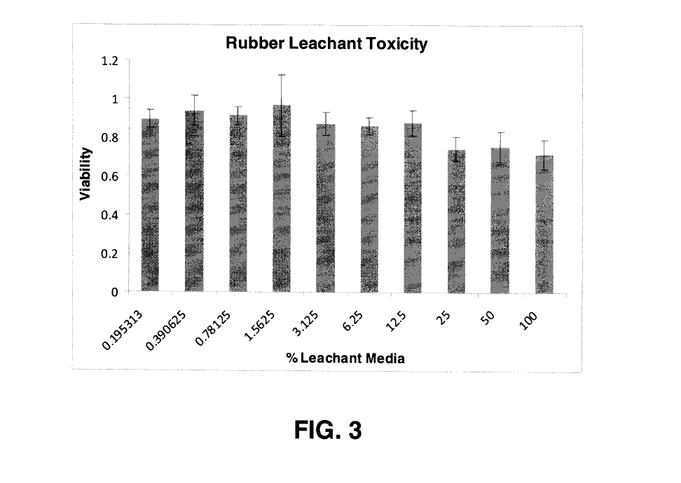

Toxicity of the materials of Examples 2 and 5 to C2C12 mouse myoblast cells was assessed. The materials of Examples 2 and 5 were surface sterilized with ethanol and UV, then incubated in cell growth media at 40° C. for 24 hours, following which the media was passed through a sterilization filter to remove any biological contaminants greater than 450 nm in size. The filtered media was dispensed into a 96 well plate, seeded with C2C12 mouse myoblast cells, and mixed with fresh growth media to obtain various dilution levels of the original incubated media. The seeded samples were incubated for an additional 48 hours, after which they were aspirated to remove the media, leaving behind the cells in the well. Each well was then replenished with fresh media and MTT assay reagent. After four hours of incubation, the media was again aspirated for removal from the well and the remaining MTT crystals were solubilized with DMSO. The absorbance at 540 nm of the contents of each well was measured to determine the original cell concentration that was present in the well. Cell viability was 80% or greater in all cases, showing that there was no apparent toxicity due to leaching from the material. The results for Example 5 are shown in FIG. 3; Example 2 displayed similar results.

### Example 9

### Cell Adhesion and Growth

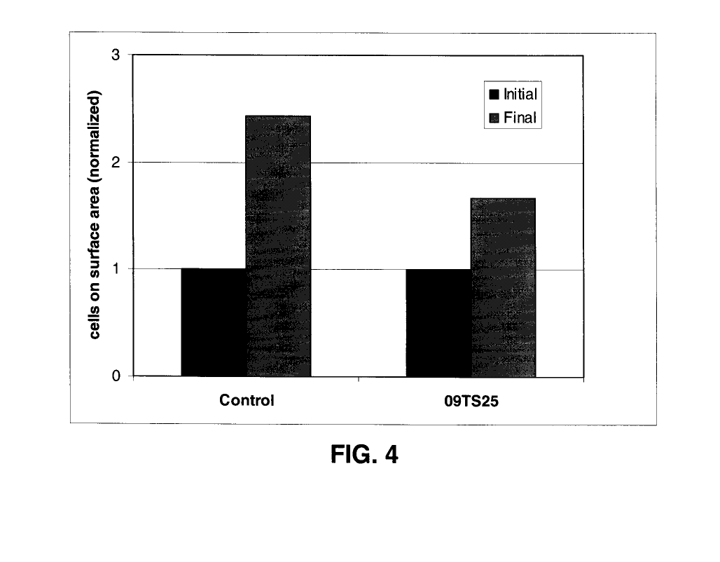

Cell proliferation tests were performed to determine the ability of materials according to the invention to support cell growth on their surface. The test measured the number of C2C12 mouse myoblast cells adhered to the material surface. Ethanol and UV sterilized 2.5 cm disks of material according to Example 2 were seeded with a 500 μL solution of culture media containing C2C12 cells; cell concentration was determined by hemocytometer counting. The cell covered disks were placed in a bio-cabinet for 20 minutes then an additional 3.5 mL of growth media was added to the material. Following 24 h incubation, the surface of each disk was gently rinsed with cell media to remove non-adhered cells. A trypsin wash was used to detach the cells from the surface of the material then the extracted cells were counted under a microscope on a hemocytometer, followed by concentration extrapolation. The growth on the material was compared to growth on a glass microscope slide, which was used as a control. The results are reported in Table 4 and FIG. 4.

TABLE 4
Cell Adhesion and Growth to Material Surface

Cell Count

| | Initial | Final | Normalized Growth | Growth % |
|---|---|---|---|---|
| Control | 6250 | 15208 | 2.43 | 143 |
| 09TS25 | 6250 | 10417 | 1.67 | 67 |

It was determined that cell growth is viable on the surface of Example 2. An increase in the population of cells on the Example 2 material of 67% was measured, while the control had an increase in population of 143%. These experiments indicate that the material is likely to be bio-compatible and non-toxic to cell growth.

Although not limited thereto, the compounds of the present invention are useful in a variety of technical fields. Such fields include, but are not limited to, biomedical applications (e.g., use in stents), tire applications (e.g. use in innerliners), food-related packaging applications, pharmaceutical closures and in various sealant applications.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

1. A highly branched arborescent block copolymer, comprising:
a. an arborescent polymer core having more than one branching point, the arborescent polymer core having a high glass-transition temperature (T_{g}) of greater than 40° C.; and,
b. branches attached to the arborescent polymer core terminated in polymer endblock segments having a low T_{g} of less than 40° C.

2. The copolymer of claim 1, wherein the copolymer exhibits thermoplastic elastomeric properties.

3. The copolymer of claim 1, wherein the copolymer comprises at least 65 wt % endblock segments.

4. The copolymer of claim 1, wherein the molecular weight (Mn) of the end blocks is at least 50,000 g/mol.

5. The copolymer of claim 1, wherein the arborescent core comprises styrenic monomers.

6. The copolymer of claim 5, wherein the styrenic monomers comprise para-methylstyrene.

7. The copolymer of claim 1, wherein the endblock segments comprise isoolefin monomers.

8. The copolymer of claim 7, wherein the isoolefin monomers comprise isobutene.

9. The copolymer of claim 7, wherein the endblock segments further comprise conjugated diene monomers.

10. The copolymer of claim 9, wherein the conjugated diene monomers comprise isoprene.

11. The copolymer of claim 1, wherein the core has a branching frequency of from about 0.5 to about 30.

12. The copolymer of claim 1, wherein the core has a branching frequency of from about 0.9 to about 10.

13. The copolymer of claim 1, wherein 250 mg of the polymer leaches less than 100 ppm of any single leachable compound when analyzed by GC-MS after 300 hours of extraction in 5 mL of de-ionized water at 40° C.

14. The copolymer of claim 1, wherein a surface of the polymer is capable of supporting cell growth.

15. A coating for a medical device or a medical device made from the arborescent copolymer of claim 1.

16. An end-functionalized arborescent polymer comprising the reaction product of at least one inimer and at least one para-methylstyrene monomer, wherein the end-functionalized arborescent polymer has been end-functionalized with greater than about 65 weight percent end blocks derived from a homopolymer or copolymer having a low glass transition temperature (T_{g}) of less than 40° C.

17. The end functionalized arborescent polymer of claim 16, wherein the molecular weight (Mn) of the end blocks is at least 50,000 g/mol.

18. The end-functionalized arborescent polymer of claim 16, wherein the at least one inimer compound has a formula as shown below: 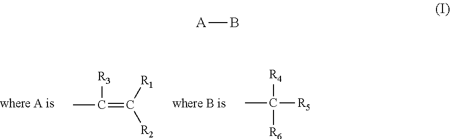
where R₁, R₂, R₃, R₄, R₅ and R₆ are each independently selected from hydrogen, linear or branched C₁ to C₁₀ alkyl, or C₅ to C₈ aryl, or
where R₁, R₂, and R₃ are all hydrogen, or
where R₄, R₅ and R₆ are each independently selected from hydrogen, hydroxyl, bromine, chlorine, fluorine, iodine, ester (—O—C(O)—R₇), peroxide (—OOR₇), and —O—R₇, where R₇ is an unsubstituted linear or branched C₁ to C₂₀ alkyl, an unsubstituted linear or branched C₁ to C₁₀ alkyl, a substituted linear or branched C₁ to C₂₀ alkyl, a substituted linear or branched C₁ to C₁₀ alkyl, an aryl group having from 2 to about 20 carbon atoms, an aryl group having from 9 to 15 carbon atoms, a substituted aryl group having from 2 to about 20 carbon atoms, or a substituted aryl group having from 9 to 15 carbon atoms, or
where one of R₄, R₅ and R₆ are either a chlorine or fluorine, and the remaining two of R₄, R₅ and R₆ are independently selected from an unsubstituted linear or branched C₁ to C₂₀ alkyl, an unsubstituted linear or branched C₁ to C₁₀ alkyl, a substituted linear or branched C₁ to C₂₀ alkyl, or a substituted linear or branched C₁ to C₁₀ alkyl, or
where any two of R₄, R₅ and R₆ can together form an epoxide, and the remaining R group in this case is either a hydrogen, an unsubstituted linear or branched C₁ to C₁₀ alkyl, or a substituted linear or branched C₁ to C₁₀ alkyl.

19. The end-functionalized arborescent polymer composition of claim 18, wherein portions A and B of inimer compound (I) are joined to one another via a benzene ring.

20. The end-functionalized arborescent polymer composition of claim 18, wherein portions A and B of inimer compound (I) are joined to one another via the linkage shown below in Formula (II): 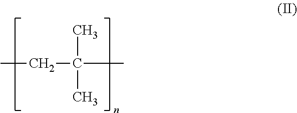
where n is an integer in the range of 1 to about 12.

21. The end-functionalized arborescent polymer composition of claim 20, wherein n is an integer in the range of 1 to about 6.

22. The end-functionalized arborescent polymer composition of claim 20, wherein n is equal to 1 or 2.

23. The end-functionalized arborescent polymer of claim 18, wherein the at least one isoolefin compound has a formula as shown below: 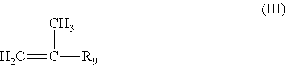
where R₉ is C₁ to C₄ alkyl group such as methyl, ethyl or propyl.

24. The end-functionalized arborescent polymer of claim 17, wherein the one or more end-functionalized portions of the polymer are derived from one or more homopolymers of isobutene.

25. The end-functionalized arborescent polymer of claim 17, wherein the one or more end-functionalized portions of the polymer are derived from one or more copolymers of an isoolefin and a conjugated diene.

26. The end-functionalized arborescent polymer of claim 25, wherein the isoolefin comprises isobutene and the conjugated diene comprises isoprene.

27. The end-functionalized arborescent polymer of claim 17, where the inimer compound is selected from 4-(2-hydroxyisopropyl)styrene, 4-(2-methoxyisopropyl)styrene, 4-(1-methoxyisopropyl)styrene, 4-(2-chloroisopropyl)styrene, 4-(2-acetoxyisopropyl)styrene, 2,3,5,6-tertamethyl-4-(2-hydroxy isopropyl)styrene, 3-(2-methoxyisopropyl)styrene, 4-(epoxyisopropyl)styrene, 4,4,6-trimethyl-6-hydroxyl-1-heptene, 4,4,6-trimethyl-6-chloro-1-heptene, 4,4,6-trimethyl-6,7-epoxy-1-heptene, 4,4,6,6,8-pentamethyl-8-hydroxyl-1-nonene, 4,4,6,6,8-pentamethyl-8-chloro-1-nonene, 4,4,6,6,8-pentamethyl-8,9-epoxy-1-nonene, 3,3,5-trimethyl-5-hydroxyl-1-hexene, 3,3,5-trimethyl-5-chloro-1-hexene, 3,3,5-trimethyl-5-6-epoxy-1-hexene, 3,3,5,5,7-pentamethyl-7-hydroxyl-1-octene, 3,3,5,5,7-pentamethyl-7-chloro-1-octene, or 3,3,5,5,7-pentamethyl-7,8-epoxy-1-octene.

28. The end-functionalized arborescent polymer of claim 17, where the inimer compound is selected from 4-(2-methoxyisopropyl)styrene or 4-(epoxyisopropyl)styrene.

29. The end-functionalized arborescent polymer of claim 17, wherein the end-functionalized arborescent polymer further comprises at least one filler.

30. A process for producing a highly branched arborescent copolymer comprising:
a. copolymerizing a reaction mixture comprising at least one inimer and at least one para-methylstyrene monomer in an inert polar solvent in the presence of a Lewis acid halide co-initiator at a temperature of from about −20° C. to about −100° C. to form a highly branched core;
b. monitoring the reaction mixture for a temperature decrease, indicating substantial consumption of the para-methylstyrene monomer;
c. adding an isoolefin monomer to the reaction mixture to form endblocks on the highly branched core, thereby producing the arborescent copolymer; and,
d. separating the arborescent copolymer from the polar solvent.

31. The process of claim 30, wherein the process further comprises purifying the arborescent copolymer following separation from the solvent to a purity level suitable for introduction of the copolymer to the human body without exhibiting symptoms of rejection.

32. The process of claim 30, wherein the process further comprises purifying the inimer to a level of at least 99% purity prior to copolymerizing with the para-methylstyrene monomer.
